(19) United States
(12) Patent Application Publication
(10) Pub. No.: US 2011/0302224 A1
(43) Pub. Date: Dec. 8, 2011

(54) DATA STORAGE DEVICE WITH PRELOADED CONTENT

(76) Inventors: Rahav Yairi, Oranit (IL); Eitan Mardiks, Raanana (IL)

(21) Appl. No.: 12/796,267

(22) Filed: Jun. 8, 2010

(51) Int. Cl. G06F 12/00; G06F 12/10; G06F 17/30; G06F 12/02

(52) U.S. Cl. 707/824; 711/103; 711/203; 707/E17.01

(57) ABSTRACT

Data storage devices and methods that maintain pre-loaded content in storage available to a user are disclosed. A method may include, in a data storage device with a non-volatile memory and a file system database, storing content at a first location in the non-volatile memory and storing metadata at a second location of the non-volatile memory. The metadata includes an indicator of the first location for use during retrieval of the stored content from the first location. After storing the content and the metadata, the first location and the second location are denoted as empty by the file system database.

### FIELD OF THE DISCLOSURE

The present disclosure is generally related to pre-loading content on data storage devices and methods of using pre-loaded data storage devices.

### BACKGROUND

Non-volatile data storage devices including memory cards, Universal Serial Bus (USB) flash drives, and hard drives may be delivered with pre-loaded content such as applications, promotional content, or entertainment content. Although some users may be interested in the pre-loaded content, other users may be annoyed that storage space on a newly acquired data storage device stores pre-loaded content.

Generally, management of pre-loaded content on -a data storage device is left to the user that acquires the device. If the user wants the pre-loaded content, the user accesses the pre-loaded content through the file allocation tables of the device, just as the user might access user content that the user stores on the device. On the other hand, if the user is not interested in the pre-loaded content, the user may delete the pre-loaded content to free the space occupied by the pre-loaded content to gain a full capacity of the data storage device available for user content. To reduce frustration with stored content being pre-loaded on a data storage device or to potentially forestall or prevent erasure of the pre-loaded content, only a small portion of the capacity of the data storage device may be used to store pre-loaded content. By only using a small portion of the capacity of the data storage device for pre-loaded content, a majority of the storage in the data storage device is available for user content without the user first erasing the pre-loaded content. However, storing pre-loaded content in only a small portion of the capacity of the data storage device limits the type and quantity of content that may be pre-loaded to the data storage device.

### SUMMARY

Data storage devices and methods that provide pre-loaded content in a seemingly empty data storage device are disclosed. A non-volatile memory includes pre-loaded content that is not listed in a file system database (e.g. one or more file system tables) of a data storage device housing the non-volatile memory. The non-volatile memory also stores metadata that identifies locations of the pre-loaded content. Although the file system database indicates that the data storage device is empty, a user can launch an application that renders the pre-loaded content available to the user. Thus, if the user wants the pre-loaded content, the user can choose to render the pre-loaded content as regular files. However, if the user does not care about the pre-loaded content, the user can store content to the data storage device and by doing so the pre-loaded content may be overwritten without first erasing or otherwise eliminating the “dormant” pre-loaded content.

In one aspect, a method is provided. In a data storage device with non-volatile memory and a file system database, wherein the file system database contains entries that represent locations in the data storage device, actions are performed. Content is stored at a first location in non-volatile memory and metadata is stored at a second location of the non-volatile memory. The metadata includes an indicator of the first location for use during retrieval of the stored content from the first location. After storing the content and the metadata, the file system database denotes the first location and the second location as empty.

The content and the metadata may be provided in the data storage device to enable distribution of the content without reducing an available user data storage capacity of the data storage device. The data storage device may be, for example, a memory card, a Universal Serial Bus (USB) flash device, or a hard drive.

The file system database may indicate an address space of the non-volatile memory, where the address space has a beginning and an end. Non-volatile memory may be allocated from the end of the address space to store at least one of the content and the metadata. At least one additional copy of the content may be stored at a third location in the non-volatile memory, where after storing the at least one additional copy of the content, the file system database denotes the third location as empty. At least one additional copy of the metadata may be stored at a fourth location in the non-volatile memory, where after storing the at least one additional copy of the metadata, the file system database denotes the fourth location as empty.

The non-volatile memory may include physical addresses, where the data storage device is configured to prevent a group of the physical addresses that contain the content and the metadata from being overwritten until all other physical addresses have been used.

In implementations the method may further include receiving a write command from a host device operatively coupled to the data storage device to open the non-volatile memory as a block device and formatting the non-volatile memory by receiving the file system database from the host device and storing the file system database to the non-volatile memory while the non-volatile memory is open as the block device. In this implementation, storing the content at the first location is performed by receiving the content from the host device and storing the content to the first location, and storing the content at the second location is performed by receiving the metadata from the host device and storing the metadata to the second location.

In another aspect, a data storage device is provided. The data storage device includes a non-volatile memory and a file system database. The non-volatile memory includes content stored at a first location and metadata stored at a second location. The metadata includes an indicator of the first location for use during retrieval of the stored content from the first location. The file system database is configured to contain entries that represent locations of files in the non-volatile memory, where the file system database denotes that the first location and the second location are empty.

The content and the metadata may be pre-loaded to enable distribution of the content without reducing an available user data storage capacity of the data storage device. The data storage device may be, for example, a memory card, a USB flash drive.

The file system database may indicate an address space of the non-volatile memory, the address space having a beginning and an end, where the first location and the second location are proximal to the end of the address space. The non-volatile memory may include at least one additional copy of the content at a third location in the non-volatile memory, where the file system database denotes the third location as empty. The non-volatile memory may include at least one additional copy of the metadata at a fourth location in the non-volatile memory, where the file system database denotes the fourth location as empty.

In some implementations, the data storage device may further include a controller coupled to the non-volatile memory. The controller may include a logical-to-physical mapping table. The non-volatile memory may include physical addresses and the controller may be configured to prevent a group of the physical addresses that contain the content and the metadata from being overwritten until all other physical addresses have been used. The controller may, when a request for write access to a logical address associated with one or more clusters of the group is receive, update the logical-to-physical mapping table to map the logical address to an empty destination cluster outside of the group, and provide write access to the empty destination cluster.

When the data storage device is operatively coupled to a host device, the data storage device may be responsive to a write command from the host device to enable access to the non-volatile memory as a block device. The non-volatile memory may be formatted by receiving the file system database from the host and storing the file system database to the non-volatile memory.

In another aspect, an additional method is disclosed. In a data storage device with non-volatile memory, actions are performed. A write command is received from a host device operatively coupled to the data storage device to open the non-volatile memory as a block device. Content is received from the host device and content is stored to a first location while the non-volatile memory is open as the block device.

Metadata is received from the host device and the metadata may be stored to a second location while the non-volatile memory is open as the block device. The metadata may include an indicator of the first location for use during retrieval of the stored content from the first location. The file system database may contain entries that represent location in the data storage device.

The file system database may denote the first location and the second location as empty. The first location and the second location being denoted as empty enables distribution of the data storage device storing pre-loaded files without reducing an available user data storage capacity of the data storage device.

When the non-volatile memory is open as the block device, the stored content may be retrievable by reading the second location to locate an indicator of the first location and reading the stored content from the first location.

In yet another aspect, an additional data storage device is disclosed. The data storage device includes a non-volatile memory and a controller. The controller is configured to prioritize assignment of physical addresses of the non-volatile memory based on a priority table in the data storage device. The priority table may indicate priority information of data stored at the physical addresses of the non-volatile memory. The priority table may indicate an assignment order of the physical addresses.

### BRIEF DESCRIPTION OF THE DRAWINGS

FIG. 1 is a block diagram of a data storage device in which the data storage device maintains content that is not identified by a file system database of the data storage device;

FIG. 2 is a block diagram of metadata representing pre-loaded content files;

FIG. 3 is a flow diagram of an embodiment of a method of preparing a data storage device with pre-loaded content; and

FIG. 4 is a flow diagram of an embodiment of a method of rendering pre-loaded content available via a file system database of a data storage device.

### DETAILED DESCRIPTION

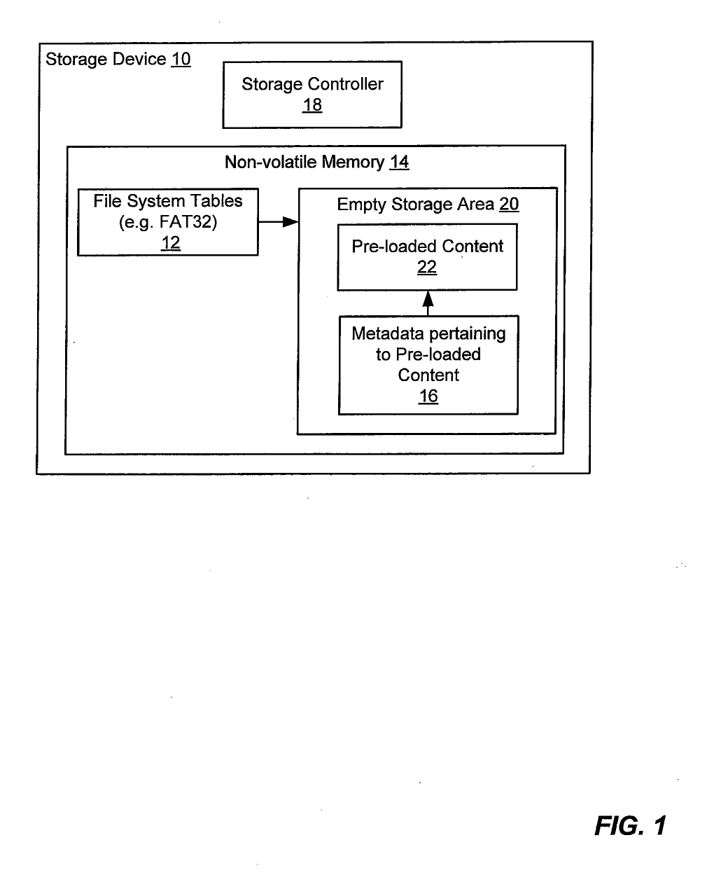

Referring to FIG. 1, a particular embodiment of a storage device 10 is depicted. The storage device 10 includes a storage controller 18 coupled to a non-volatile memory 14. The non-volatile memory 14 includes a file system database, illustrated as one or more file system tables 12. The non-volatile memory 14 also includes pre-loaded content 22 and metadata 16 pertaining to the pre-loaded content 22.

The pre-loaded content 22 and the metadata 16 are in a portion of the non-volatile memory 14 that the file system tables 12 denote as an empty storage area 20.

The storage device 10 may be a flash device such as a memory card (e.g. a Secure Digital SD® card or a micro-SD® card (trademarks of SD-3C LLC, Wilmington, Del.)) or a Universal Serial Bus (USB) flash drive. Alternatively, the storage device 10 may be a hard disk drive or other storage device. The file system tables 12 may be configured to contain entries that represent locations of files within the non-volatile memory 14. For example, the file system tables 12 may include a cluster table that indicates whether each cluster of the non-volatile memory 14 is used by a file or is unused.

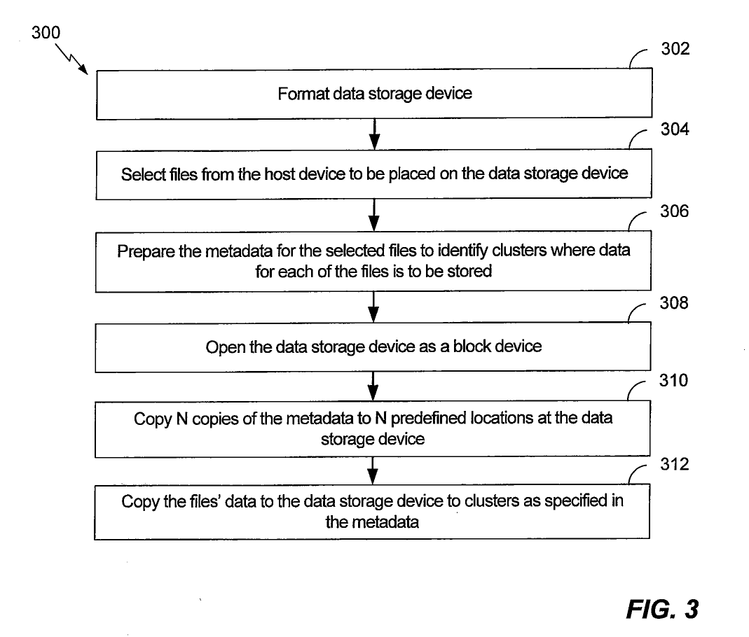

The pre-loaded content 22 may be stored at a first location and the metadata 16 may be stored at a second location within the empty storage area 20. For example, storing of the pre-loaded content 22 and/or the metadata 16 to the non-volatile memory 14 may be carried out by a manufacturer of the storage device 10 as part of the manufacturing process, by a distributor of the storage device 10, by an entity commissioned to handle pre-loading/packaging, or by another entity. An example of preparing the storage device 10 is illustrated in FIG. 3.

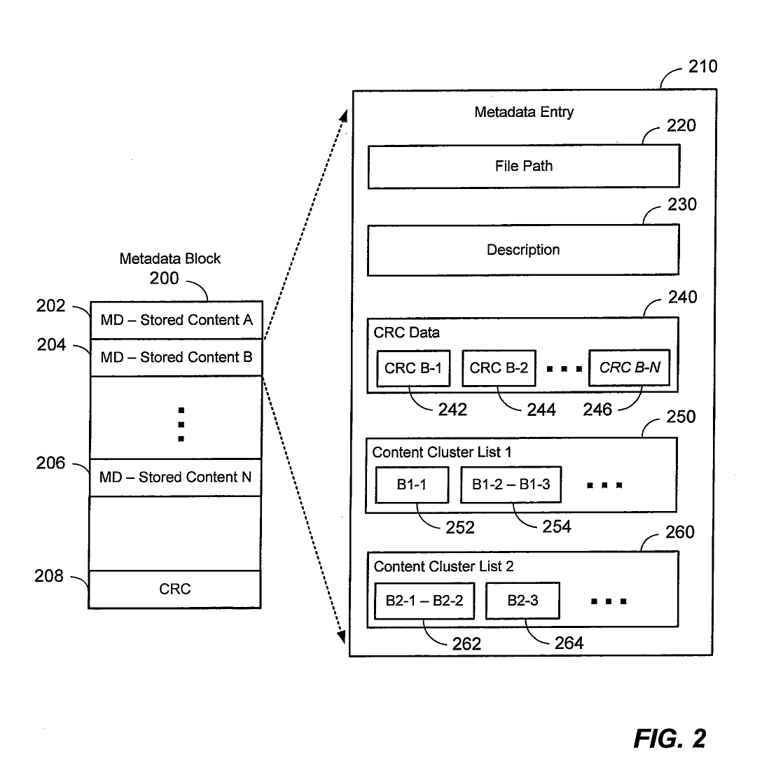

The metadata 16 includes an indicator of the first location and is used for retrieving the stored content 22 from the first location. For example, a user may execute a host application at a host while the storage device 10 is connected to the host. The host application may be pre-loaded on the storage device 10, be preinstalled on the host, or a user may download the host application from a website. In some implementations, a user may be notified of hidden preloaded content and how to activate the hidden preloaded content by means such as text on a memory device package. The host application may locate the metadata 16 and use the indicator of the first location to locate the pre-loaded content 22. The metadata 16 may have a size of one or more sectors and may include additional information, such as integrity check data and descriptive information for the pre-loaded content, as will be described in further detail in FIG. 2.

If the user is not interested in any of the dormant pre-loaded content 22, the user does not have to take any action. To a host that accesses the file system tables 12, the storage device 10 appears blank. As the user writes user data to the storage device 10, the pre-loaded content 22 and the metadata 16 may be gradually overwritten and will become unavailable.

As a result, the storage device 10 enables users that are not interested in the dormant pre-loaded content 22 to have a blank storage device with all the capacity of the non-volatile memory 14 available for storing user data. On the other hand, users that are interested in the dormant pre-loaded content 22 can launch a host application to restore the pre-loaded content 22.

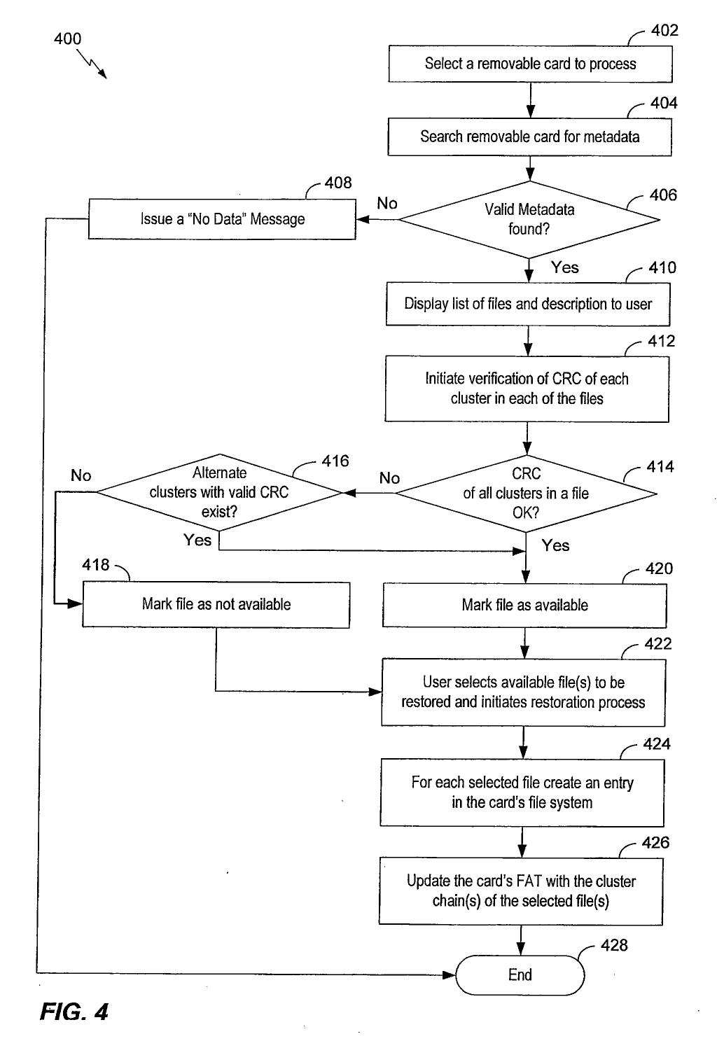

The host application may check the integrity of the dormant pre-loaded content, show the user all valid data items (e.g. files within the dormant pre-loaded content 22 that have not been overwritten by user data), and convert user selected pre-loaded content into regular operating system (OS) files. Examples of methods of locating and converting the pre-loaded content 22 into regular OS files are depicted in further detail in FIG. 4.

FIG. 2 is a diagram of metadata 200 that includes a plurality of metadata entries where each of the metadata entries provides location and other information for one of the dormant pre-loaded content files. The metadata 200 may be used in the storage device 10 of FIG. 1 to contain the metadata 16 in the empty storage area 20. The metadata 200 includes metadata entries including metadata for a stored file A202, metadata for a stored file B 204, and metadata for a stored file N 206. The metadata 200 may include metadata for all of the pre-loaded content in a data storage device. For example, the metadata 200 may include metadata for all of the pre-loaded content 22 in the empty storage area 20 of FIG. 1. Multiple copies of the metadata 200 may be stored to provide multiple redundant copies of the location and other metadata information for each of the pre-loaded content files in a data storage device.

The metadata entry 210 shows detail of the metadata for the stored file B 204. The metadata entry 210 includes a file path 220 that includes the name of the file that is stored as part of the pre-loaded content. The metadata entry 210 may also include a description 230 of the pre-loaded file represented by the metadata entry 210. The description 230 may include a textual summary of the pre-loaded content of file B.

The metadata entry 210 includes data integrity information 240, such as CRC data or parity data, for the content clusters identified by the metadata entry 210. For example, when there are one through N clusters of data in the stored file B, the clusters ranging from B-1 through B-N, there is a stored CRC data record for each of the clusters including representative CRCs: CRC B-1 242, CRC B-2 244, and CRC B-N 246. Using the CRC data, an integrity check of each of the clusters B-1 through B-N may be performed to determine whether any of the clusters has been overwritten. By enabling such an integrity check, a user may only be offered stored content files for which all of the clusters are intact. The metadata 200 may also include CRC or other data integrity information 208 for the metadata 200 itself so that a host retrieve application can determine whether the metadata 200 has been overwritten.

If only one copy of the content is placed, there may be a single CRC for the file as a whole and not per each cluster. In a particular embodiment, the metadata and pre-loaded content is placed so it is aligned to the end of the storage device as most OS write data to the storage devices starting at the lower clusters.

The metadata entry 210 also includes one or more indicators to identify locations where the pre-loaded content is stored. A first content cluster list 250 includes indicators of each individual cluster or chain of clusters where a first copy of the stored pre-loaded content is located. The clusters may or may not be contiguous. The first content cluster list 250 includes an address, a pointer, or other indicator of a cluster B1-1 252, a group of contiguous clusters B1-2 through B1-3 254, etc. A second content cluster list 260 includes indicators of each individual cluster or chain of clusters where a second copy of the pre-loaded content is located. The second content cluster list 260 includes an indicator of a chain of contiguous clusters B2-1 through B2-2 262, an indicator of a cluster B2-3 264, etc. The metadata entries 202, 204, and 206 provide path, description, integrity, and location information for the stored content files to enable access to such pre-loaded files even though such files are not initially listed in the file system tables 12 as shown in FIG. 1.

FIG. 3 is a flow diagram of an embodiment of a method 300 of loading a data storage device with pre-loaded content. The method 300 may be performed by a host device operatively coupled to the data storage device. The data storage device is formatted, i.e. building the file system database in the device, and data is transferred to empty clusters of the data storage device while maintaining a configuration of the data storage device to operate as an empty device. For example, the formatting of the data storage device may include a file allocation table of the data storage device indicating that an entire storage capacity of the data storage device is available. Metadata indicating cluster locations of the pre-loaded content may be copied to predefined locations at the data storage device. The copy may include multiple instances of content files and metadata.

A particular implementation of the method 300 includes the storage device 10 of FIG. 1, which may be a memory card, a Universal Serial Bus flash drive, a solid-state device or mechanical hard drive, or another non-volatile storage device, being formatted, at 302. In formatting the data storage device, the host device (not shown in FIG. 1) used to prepare the storage device 10 is coupled to the storage device 10 and the host device may write sectors of data to the non-volatile memory 14 that signify a file system database (e.g. the file system tables 12). The file system database indicates that the non-volatile memory 14 is empty, i.e. the host device assumes the memory does not hold file data and is available for new content.

Files are selected from the host device to be placed on the storage device 10, at 304. The files may be selected by a user of the host device that enters commands or makes selections from a host application's graphical user interface to select the files. The files may also be selected in accordance with a previously-created list that is created on or provided to the host device. The files may include any type of files that may be accommodated in the non-volatile memory 14, such as text, image, audio, video, and executable files. The files may be selected for any reason or according to criteria specified by a provider of the storage device. For example, the files may be selected by a distributor or manufacturer of the data storage device for distribution to end-users of the data storage device. Formatting and pre-loading of the selected files may be performed by the device manufacturer, distributor, or other entity prior to providing the data storage device to end-users.

Metadata is prepared for the selected files, at 306. As described with reference to FIG. 2, the metadata may be presented in a metadata 200 that includes entries 202, 204, and 206 that enable access to the stored pre-loaded files even though the pre-loaded files are not listed in the file system database (e.g. the file system tables 12 of FIG. 1). A memory map of the non-volatile memory 14 may be created on the host device to enable selection of clusters where the pre-loaded content files are to be stored. For each of the files to be stored at the non-volatile memory 14, a number of clusters sufficient to accommodate each of the files is identified. Data integrity information, such as parity or CRC data, is generated for each cluster and/or file. The known positions of the clusters and the data integrity information are then collected to form the metadata for the file.

The storage device 10 coupled to the host device is opened as a block device, at 308. Accessing a storage device by a host application is typically involved with a “file open” operation. The host file system searches for the file location in the storage and translates file read/write requests from relative sector addresses to device absolute sector addresses. In some cases, a host application may need to access the storage device directly, bypassing the host file system. In order to obtain direct access, the storage device is un-mounted from the host file system and then may be accessed in a special mode where the host application specifies absolute sector addresses instead of file relative sector addresses. “Opening the device as a block device” refers to this special access mode.

The storage device 10 may be responsive to a write command from the host device to enable access to the non-volatile memory 14 as a block device. By opening the storage device 10 as a block device, the host device may write the pre-loaded content 22 to the cluster locations that were selected for storage and that are stored in the metadata for the content. Also, by writing to the storage device 10 as a block device, no entries are generated in the file system tables 12 so that the storage device 10 appears to be empty from a file system perspective even when the storage device 10 is not empty.

Once the data storage device is opened as a block device at 308, N copies of the metadata (where N is greater than or equal to one) for each of the selected files may be written to N predefined locations at the data storage device, at 310. The metadata, which identifies the location and other information about pre-loaded files as described with reference to the example illustrated in FIG. 2, is written to selected locations in the non-volatile memory. For redundancy, i.e., to preserve a way to access the pre-loaded content if one copy of the metadata is overwritten, N copies of the metadata may be stored in the non-volatile memory 14 of the storage device 10. To help prevent overwriting, the N copies of the metadata may be written to N different locations distributed over the non-volatile memory 14.

The data of the files is copied to the storage device 10 in the clusters specified by the metadata, at 312. By accessing the storage device 10 as a block device, the host device can specify the addresses in the non-volatile memory 14 at which the data is stored. Thus, at the selected addresses for the clusters that were chosen and stored in the metadata at 304 and 306, the data of the files is written to the non-volatile memory 14 of the storage device 10. Alternatively, the data may be written to the storage device 10 prior to, or concurrently with, writing the metadata to the storage device 10 (i.e. 312 may be performed before 310).

Again, no entries are written to the file system tables 12 to represent the pre-loaded content, so the storage device 10 appears to be empty and behaves as if it were empty (e.g. the entire capacity of the data storage device appears available). However, by using a host application that is programmed with one or more of the N locations of the N copies of metadata, such as described with reference to the example illustrated in FIG. 4, the host application can access the metadata and, using the cluster locations stored in the metadata, the host application can access the files from the clusters specified in the metadata as long as the clusters have not been overwritten. Alternatively the host application may search the device for metadata where the metadata is identified by a predefined signature.

Thus, in a data storage device with a non-volatile memory, a method may include formatting the device by receiving a command from a host device operatively coupled to the data storage device to open the non-volatile memory as a block device and by receiving a file table or file system database at the storage device. The file system or file system database is stored in the non-volatile memory while the non-volatile memory is open as the block device. Content may be received from the host device and stored to a first location while the non-volatile memory is open as the block device, and metadata may be received from the host device and stored to a second location while the non-volatile memory is open as the block device. The metadata includes an indicator of the first location for use during retrieval of the stored content from the first location.

The file system database contains entries that represent locations in the data storage device. After formatting the non-volatile memory and after storing the content and the metadata, the first location and the second location are denoted as empty by the file system database. The first location and the second location being denoted as empty by the file system database enables distribution of the data storage device storing pre-loaded files without reducing an available user data storage capacity of the data storage device. The stored content is retrievable, when the non-volatile memory is open as the block device, by reading the second location to locate the indicator of the first location, and reading the stored content from the first location. For example, the metadata 200 of FIG. 2 may be read from the second location and parsed to locate the first content cluster list 250. Each cluster of the non-volatile memory indicated by the first content cluster list 250 may be read to retrieve the stored content associated with the first content cluster list 250.

A manufacturer of the data storage device may pre-load the content and the metadata to enable distribution of the content without reducing an available user data storage capacity of the data storage device. The locations of the content and the metadata stored to the data storage device may be selected to preserve the pre-loaded content from being overwritten by user data until the memory is otherwise full. For example, the file system database of the storage device 10 of FIG. 1 may indicate an address space of the non-volatile memory 14. The address space may extend from a starting address at a beginning of the address space (e.g. address “0”) to a last address at an end of the address space corresponding to a total storage capacity of the non-volatile memory 14. The non-volatile memory 14 may be allocated from the end of the memory address space to store at least one of the content 22 and the metadata 16, so that the first location of the pre-loaded content 22 and the second location of the metadata 16 are proximal to the end of the address space.

To further preserve the pre-loaded data as usable data, in addition to storing pre-loaded content at the first location and metadata at the second location, preparing the data storage device may further include storing at least one additional copy of the content at a third location of the non-volatile memory, or storing at least one additional copy of the metadata at a fourth location of the non-volatile memory, or both. The third location and the fourth location are denoted as empty by the file system database after storing the one or more additional copies of the content and/or the metadata.

A flash memory storage device typically keeps a translation table that translates the sector number as provided by the host to a physical location on the memory. The card controller typically keeps a pool of free sectors, and whenever there is a write request to a new sector, the controller allocates a free sector on the card and associates its physical address with the host logical sector number. In the data storage device with preloaded content disclosed herein, the non-volatile memory may include physical addresses and the data storage device may be configured to prevent a group of the physical addresses that contain the content and the metadata from being overwritten until all other physical addresses have been used. For example, the controller of the data storage device may be configured to prioritize assignment of physical addresses of the non-volatile memory based on a priority table in the data storage device. The priority table indicates priority information of data stored at the physical addresses of the non-volatile memory. To illustrate, the priority table may indicate an assignment order of the physical addresses to enable the controller to assign physical addresses according to the assignment order.

The storage device 10 of FIG. 1 may be configured to prevent the clusters of the non-volatile memory 14 that store the pre-loaded content 22 and the metadata 16 from being overwritten until all other physical addresses of the non-volatile memory 14 have been used. To illustrate, the storage controller 18 may include a logical-to-physical mapping table. When a request for write access to a logical address associated with one or more sectors of the group is received, the group is prevented from being overwritten by updating the logical-to-physical mapping table to map the logical address to a physical address of an empty destination sector outside of the group. Write access is provided to the empty destination sector, such as for storing user content from the host device.

FIG. 4 is a flow diagram of an embodiment of a method 400 of making preloaded content available via the file system tables 12 of the storage device 10. A removable card or other data storage device is selected for processing, at 402. To select the card, the user may select one of a number of available cards or other data storage devices and insert the selected removable card or otherwise operatively couple the selected data storage device to a corresponding port, such as a Universal Serial Bus (USB) port for a USB flash device, on the host device. The host device may include a file system that indicates that the selected data storage device is empty and the host device may also include or be coupled to a display device.

The storage device is searched for metadata at a metadata location that identifies pre-loaded content on the storage device, at 404. The storage device may be searched using a host application as described with reference to FIG. 3 that is programmed to include metadata identifying the cluster locations of pre-loaded files. The host application may search the data storage device for metadata that is identified by a special predefined data pattern. The metadata may be stored in a storage device according to a storage pattern such as at

$$O + \frac{S - O}{20} * n ,$$

where S is a total sector count for a device and O is a predefined offset from a start of a device. N may be any number, but in one example, n is an integer between zero and 19 such that there are twenty places for the host application to look for the metadata, although the number of copies of the metadata stored on the storage device may not be known to the host application.

It is determined whether metadata has been found, at 406. The metadata may include a particular identifier in a header that indicates metadata with information about pre-loaded content. Before indicating that metadata has been found, at 406, the host application may perform a data integrity check on the metadata to verify that the metadata has not been at least partially overwritten. When the host application does not find any valid metadata, the method proceeds to issue a “no data” message, at 408. The “no data” message may be presented via a user interface of a host device, such as in the form of a visual message presented via a display of the host device, and the method 400 then ends, at 428.

On the other hand, if it is determined that valid metadata has been found, at 406, the method 400 proceeds to display a list of files available and descriptions of the files to the user, at 410. The host device reads the metadata entries, such as the detailed metadata entry 210 (FIG. 2), to read the name of each of the files from the file path 220 and the description of the file 230. The host device then displays each of the files and the description of each of the files via a display device of the host device.

A check of the integrity of each of the clusters (e.g., by CRC matching or another technique) in each of the files identified at 410 is initiated, at 412. The host device reads the CRC data 240 or other data integrity information for each of the content clusters in the cluster lists 250 and 260 stored in the metadata entry. For example, the host device may access the metadata, read a data integrity entry for a first cluster of a file (e.g. the CRC entry 242), locate a copy of the first cluster (by accessing the list 250), calculate CRC data from the located copy of the first cluster and determine if the calculated CRC data matches the CRC entry 242 read from the metadata. If the calculated CRC data matches the CRC entry 242, the cluster is considered valid and processing continues to a next cluster in the list 250.

If it is determined that CRC data or other data integrity information does not match for one or more of the clusters in the file according to the list 250, at 414, the host device determines if one or more alternate clusters with valid, matching CRC data exists, at 416. For example, multiple copies of stored content may be written to the storage device 10 and additional cluster lists for the additional copies (e.g. the list 260 of FIG. 2) may also be stored the metadata. Thus, if CRC data for a particular cluster of one of the copies of a pre-loaded content file (e.g. the first cluster list 250) does not match the stored CRC data in the metadata entry for the stored content file, the particular cluster is considered to be “unavailable”. The host device checks the metadata to determine if there is another copy of the pre-loaded content file (e.g. the second cluster list 260), identifies a cluster in the other copy that corresponds to the unavailable cluster, and performs CRC matching with the corresponding cluster.

If it is determined that the CRC data of the clusters in a file matches the stored CRC data at 414, or that the CRC data of one or more alternate clusters matches the stored CRC data at 416, the file is marked as available, at 420. The file may be marked as available by the host device signifying on the host display that the file is available or, alternatively, by not signifying on the host display that the file is unavailable. Otherwise, if it is determined that the CRC data of the clusters in a file does not match the stored CRC data, at 414, and that the CRC data of one or more alternate clusters does not match the stored CRC data at 416, the file is marked as not available, at 418. For files that are not available, the host device may mark the files as unavailable on the display of the host device or may not list the files on the display of the host device.

After the available and unavailable files are marked, at 420 and at 418, respectively, the user is presented with an opportunity to select one or more available files to be restored. Receiving a user selection of the one or more available files to be restored may initiate a restoration process of a selected file so that the selected file is available for access by the file system. The restoration process may cause the clusters of the pre-loaded content to be copied to new locations in the data storage device as user content clusters or may access the clusters of the pre-loaded content in place. Alternatively, the data may be copied to another storage device, e.g. to the host local hard disk. For each selected file, the host device creates an entry in the file system database (e.g. the file system tables 12) for the new user content file that was formerly inaccessible via the file system, at 424. The host device then updates the file system (e.g., a file allocation table of the file system tables 12) to specify the clusters where the new content file is located, at 426. The file system tables 12 may be updated by the host device to associate a chain of clusters with the new user content file, and the method ends, at 428.

Although various components depicted herein are illustrated as block components and described in general terms, such components may include one or more microprocessors, state machines, or other circuits configured to enable the storage device 10 to perform the particular functions attributed to such components, or any combination thereof For example, the storage controller 18 may represent one or more physical components, such as hardware controllers, state machines, logic circuits, or other structures.

In a particular embodiment, the storage device 10 may be a portable device configured to be selectively coupled to one or more external devices. However, in other embodiments, the storage device 10 may be attached or embedded within one or more host devices, such as within a housing of a portable communication device. For example, the storage device 10 may be within a packaged apparatus such as a wireless telephone, personal digital assistant (PDA), gaming device or console, portable navigation device, camera, or other device that uses internal non-volatile memory. In a particular embodiment, a storage device includes a non-volatile memory, such as a flash memory (e.g., NAND, Multi-Level Cell (MLC), Divided bit-line NOR (DINOR), AND) or any other type of memory that can be operated as a block device.

The illustrations of the embodiments described herein are intended to provide a general understanding of the various embodiments. Other embodiments may be utilized and derived from the disclosure, such that structural and logical substitutions and changes may be made without departing from the scope of the disclosure. This disclosure is intended to cover any and all subsequent adaptations or variations of various embodiments. Accordingly, the disclosure and the figures are to be regarded as illustrative rather than restrictive.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
in a data storage device with a non-volatile memory and a file system database,
wherein the file system database contains entries that represent locations in the data storage device, performing:
storing content at a first location in the non-volatile memory; and
storing metadata at a second location of the non-volatile memory, wherein the metadata includes an indicator of the first location for use during retrieval of the stored content from the first location, and
wherein after storing the content and the metadata, the first location and the second location are denoted as empty by the file system database.

2. The method of claim 1, wherein the content and the metadata are provided in the data storage device to enable distribution of the content without reducing an available user data storage capacity of the data storage device.

3. The method of claim 1, wherein the data storage device is a memory card.

4. The method of claim 1, wherein the data storage device is a Universal Serial Bus (USB) flash drive.

5. The method of claim 1, wherein the file system database indicates an address space of the non-volatile memory, the address space having a beginning and an end, and further comprising allocating the non-volatile memory from the end of the address space to store at least one of the content and the metadata.

6. The method of claim 1, further comprising storing at least one additional copy of the content at a third location in the non-volatile memory, and wherein after storing the at least one additional copy of the content, the third location is denoted as empty by the file system database.

7. The method of claim 1, further comprising storing at least one additional copy of the metadata at a fourth location in the non-volatile memory, and wherein after storing the at least one additional copy of the metadata, the fourth location is denoted as empty by the file system database.

8. The method of claim 1, wherein the non-volatile memory includes physical addresses, and wherein the data storage device is configured to prevent a group of the physical addresses that contain the content and the metadata from being overwritten until all other physical addresses have been used.

9. The method of claim 1, wherein non-volatile memory is a flash memory, and further comprising:
receiving a write command from a host device operatively coupled to the data storage device to open the non-volatile memory as a block device; and
formatting the non-volatile memory by receiving the file system database from the host device and storing the file system database to the non-volatile memory while the non-volatile memory is open as the block device;
wherein storing the content at the first location is performed by receiving the content from the host device and storing the content to the first location, and
wherein storing the metadata at the second location is performed by receiving the metadata from the host device and storing the metadata to the second location.

10. A data storage device comprising:
a non-volatile memory including:
content stored at a first location; and
metadata stored at a second location, wherein the metadata includes an indicator of the first location for use during retrieval of the stored content from the first location; and
a file system database configured to contain entries that represent locations of files in the non-volatile memory,
wherein the file system database denotes that the first location and the second location are empty.

11. The data storage device of claim 10, wherein the content and the metadata are pre-loaded to enable distribution of the content without reducing an available user data storage capacity of the data storage device.

12. The data storage device of claim 10, wherein the data storage device is a memory card.

13. The data storage device of claim 10, wherein the data storage device is a Universal Serial Bus (USB) flash drive.

14. The data storage device of claim 10, wherein the file system database indicates an address space of the non-volatile memory, the address space having a beginning and an end, and wherein the first location and the second location are proximal to the end of the address space.

15. The data storage device of claim 10, wherein the non-volatile memory further includes at least one additional copy of the content at a third location in the non-volatile memory, and wherein the third location is denoted as empty by the file system database.

16. The data storage device of claim 10, wherein the non-volatile memory further includes at least one additional copy of the metadata at a fourth location in the non-volatile memory, and wherein the fourth location is denoted as empty by the file system database.

17. The data storage device of claim 10, further comprising a controller coupled to the non-volatile memory, wherein the controller includes a logical-to-physical mapping table, wherein the non-volatile memory includes physical addresses, and wherein the controller is configured to prevent a group of the physical addresses that contain the content and the metadata from being overwritten until all other physical addresses have been used by, when a request for write access to a logical address associated with one or more clusters of the group is received:
updating the logical-to-physical mapping table to map the logical address to an empty destination cluster outside of the group, and
providing write access to the empty destination cluster.

18. The data storage device of claim 10, wherein when the data storage device is operatively coupled to a host device, the data storage device is responsive to a write command from the host device to enable access to the non-volatile memory as a block device, and the non-volatile memory is formatted by receiving the file system database from the host device and storing the file system database to the non-volatile memory.

19. The data storage device of claim 10, further comprising:
a controller configured to prioritize assignment of physical addresses of the non-volatile memory based on a priority table in the data storage device, wherein the priority table indicates priority information of the data stored at physical addresses of the non-volatile memory.

20. The data storage device of claim 19, wherein the priority table indicates an assignment order of the physical addresses.

21. A method comprising:
in a data storage device with a non-volatile memory, performing:
receiving a write command from a host device operatively coupled to the data storage device to open the non-volatile memory as a block device;
receiving content from the host device and storing the content to a first location while the non-volatile memory is open as the block device; and
receiving metadata from the host device and storing the metadata to a second location while the non-volatile memory is open as the block device,
wherein the metadata includes an indicator of the first location for use during retrieval of the stored content from the first location,
wherein file system database contains entries that represent locations in the data storage device,
wherein after formatting the non-volatile memory and storing the content and the metadata, the first location and the second location are denoted as empty by the file system database, and
wherein the first location and the second location being denoted as empty by the file system database enables distribution of the data storage device storing pre-loaded files without reducing an available user data storage capacity of the data storage device.

22. The method of claim 21, wherein the stored content is retrievable by performing, when the non-volatile memory is open as the block device:
reading the second location to locate the indicator of the first location, and
reading the stored content from the first location.
